(19) United States
(12) Patent Application Publication
(10) Pub. No.: US 2023/0376789 A1
(43) Pub. Date: Nov. 23, 2023

(54) AUTOMATIC RULE INDUCTION FOR SEMI-SUPERVISED TEXT CLASSIFICATION

(71) Applicant: MICROSOFT TECHNOLOGY LICENSING, LLC, Redmond, WA (US)

(72) Inventors: Reid Allen PRYZANT, Seattle, WA (US); Chenguang ZHU, Issaquah, WA (US); Ziyi YANG, Bellevue, WA (US); Yichong XU, Bellevue, WA (US); Nanshan ZENG, Bellevue, WA (US)

(21) Appl. No.: 17/837,358

(22) Filed: Jun. 10, 2022

Related U.S. Application Data
(60) Provisional application No. 63/344,728, filed on May 23, 2022.

(51) Int. Cl. G06N 5/00; G06K 9/62

(52) U.S. Cl. CPC G06N 5/003; G06K 9/6259; G06K 9/6247

(57) ABSTRACT

Systems and techniques are provided for facilitating the automatic discovery and application of rules for refining the training of pretrained models, such as natural language processing models. Weak symbolic rules are automatically generated from the identification and processing of sparse labeled data by the pretrained model(s). Once the weak rules are generated, they are integrated into the model(s) via an attention mechanism to supplement the direct training performed by the sparse labeled data and to thereby boost a supervision signal generated by the sparse labeled data on any newly processed unlabeled data in the intended runtime environment(s) where the models are applied.

### RELEVANT ART

This application claims the benefit of U.S. Provisional Patent Application Ser. No. 63/344,728, filed May 23, 2022, entitled “AUTOMATIC RULE INDUCTION FOR SEMI-SUPERVISED TEXT CLASSIFICATION,” and which application is expressly incorporated herein by reference in its entirety.

### BACKGROUND

When a machine-learning model is initially trained on a first generic set of labeled training data, it is often necessary to refine the model with new training data that is specific to an intended use or runtime environment and application dataset. Unfortunately, it can sometimes be difficult and expensive to obtain new labeled training data that would be required for performing such refinement of a pretrained model. In this regard, it is noted that a common challenge associated with most conventional pretrained neural networks is obtaining enough labeled training data to refine the training of those neural networks so that they can perform at a desired level of accuracy in their runtime environments and/or with newly applied datasets.

Some development has been made for defining and applying rules that can supplement any labeled data that is available for refining the training of pretrained neural networks. However, in such instances, when only a limited amount of labeled data is available, the new rules that are created are somewhat difficult to define and apply, as they are created by human inspection and intuition.

In view of the foregoing, there is an ongoing need for improved systems and methods for generating rules for classification models.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed methods, systems and devices are directed towards embodiments for facilitating the generation and application of rules for training or otherwise modifying pretrained machine-learning models, such as natural language processing models and other types of neural network models.

In some embodiments, systems are configured for modifying a trained classification model. In such embodiments, the systems are configured to identify a trained classification model to be refined or otherwise modified. The systems are also configured to access a data set of labeled data and unlabeled data configured for being classified by the trained classification model. The labeled data may be sparse data for a new environment or a new dataset for which the model is not previously trained and in which the new dataset includes unique unlabeled data that the model has not been trained to classify. The sparse labeled data includes less than all of the new dataset, or less than at least half of the new dataset.

Once the systems identify the pretrained classification model and the new labeled data and unlabeled data, for the new dataset/environment, the systems apply the identified labeled and unlabeled data to a text featurization module to generate a plurality of feature vector values. Then, the systems apply the feature vector values to a data value transformer to generate a plurality of transformed vector values that are ultimately applied to a rule generator to generate a set of rules for classifying new unlabeled data.

The systems are also configured to apply/integrate the newly generated set of rules to the trained classification model to generate a modified classification model, and in such a manner that the modified classification model is configured to classify any new unlabeled data in the new environment/dataset based at least partially based on the set of rules.

In other embodiments, systems are configured for applying unlabeled data to a tuned classification model to classify the unlabeled data, wherein the tuned classification model is tuned/refined based on the processes described above for modifying a trained or pretrained classification model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments.

FIG. 2 illustrates an example embodiment for training a text classification model with labeled and unlabeled data.

FIG. 3 illustrates one embodiment of a flow diagram having a plurality of acts associated with methods for automatically determining rules and using those rules to tune a text classification model.

FIG. 4 illustrates one embodiment of a flow diagram having a plurality of acts associated with methods for characterizing unlabeled data based on the tuned text characterization model.

### DETAILED DESCRIPTION

Disclosed embodiments include methods, systems, and devices for automatically determining and applying rules for tuning machine-learning models, including, but not limited to techniques for modifying text classification models to perform classifications based at least in part on rules generated from sparse labeled data. More particularly, in some embodiments, systems and methods are provided for automatically determining appropriate rules for a text classification model, tuning a text classification model based on the newly developed rules, and using the text classification model to classify unlabeled data.

In some embodiments, a new general-purpose framework is proposed/utilized for performing automatic discovery and integration of symbolic rules within pretrained models to enhance or refine the training of those models for new environments/datasets that they are originally trained to operate with.

The disclosed framework contrasts with prior neuro-symbolic model training and refinement techniques in at least two ways. First, the disclosed framework includes a fully automatic rule generation procedure, whereas prior work has focused on manually crafted rules or semi-manual rule generation procedures. In at least this regard, the disclosed embodiments provide many technical advantages and practical applications over conventional systems which require practitioners to formulate and manually apply their own intuitive rules to the pretrained models when there is only sparse labeled data available for refining the training of the models and which is applied as a second order “rule annotation” burden on top of the data labeling process.

Additionally, it will be noted that the disclosed embodiments are scalable and applicable to different environments and types of models, such that they can be applied to any classification dataset. For example, the disclosed embodiments are configured to automatically generate rules (i.e., symbolic components such as heuristics, logical formulas, program traces, network templating, blacklists, etc.) from training datasets. The automatic nature of the rule generation is a highly scalable process because it utilizes little to no labeled data and does not require human annotation of the rules that have been automatically generated. Thus, users do not need specialized knowledge when applying the model to domain-specific training datasets.

Furthermore, the model is applicable to different environments because these rules are configured to systematically generalize without little to no data. Additionally, these rules are inherently interpretable with respect to their constituent operations. When an interpretable rule has been applied to an input dataset to generate a modified dataset, it improves the user experience during analysis of the modified dataset because the user is able to understand a meaning behind the rule and thus how the model has modified the input dataset. This contrasts with conventional systems that require intensive customization with user developed rules, instead of automatically generated rules, and directed application of those rules, instead of generalized application.

At a very high level, the disclosed embodiments correspond with two core sets of processes. The first core set of processes includes generating symbolic rules from data. This involves training low-capacity machine learning models on a reduced feature space, extracting artifacts from these models which are predictive of the class labels, then converting these artifacts into rules. Such embodiments are distinguished from conventional systems that have focused on manually crafted rules or semi-manual rule generation processes in which users must formulate and implement rules by hand, as well as to label data and annotate the rules which are then used to modify the desired machine learning model. It will be appreciated that such conventional processes are time-consuming and not scalable due to the large amount of human-based model training steps that are required.

The second core set of processes relates to the application of the rules to pretrained models to amplify the training signals in the unlabeled data processed by those models. In particular, a rule-augmented self-training procedure can be adopted, for example, using an attention mechanism to aggregate the predictions of a backbone classifier (e.g. BERT) and the rules. This contrasts with prior work that focused on applying task-specific and domain-specific symbolic knowledge through weak supervision signals (e.g., requiring labeled data for supervised instead of self-supervised training), special loss functions, model architectures, and prompt templates. It will also be appreciated that the self-supervised training with sparse data according to the disclosed embodiments enable the tuning of a model with less labeled data than is possible with conventional systems.

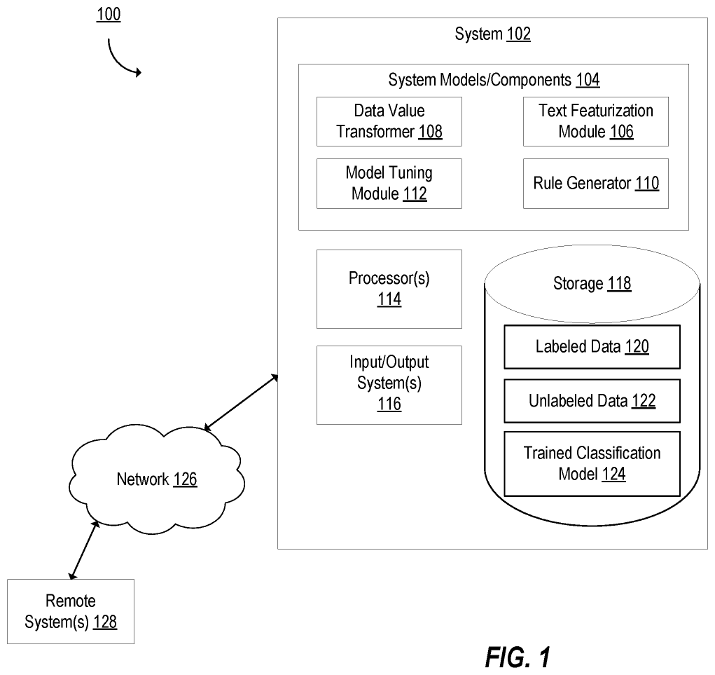

Attention will now be directed to FIG. 1, which illustrates a computing system (e.g., system 102) which may include and/or be used to implement aspects of the disclosed invention, including the foregoing core processes. As shown, the computing system includes a plurality of system models and data types associated with inputs and outputs of the text characterization model.

The system 102, for example, includes one or more processor(s) 114 (such as one or more hardware processor(s)), system models/components 104, and a storage 118 storing labeled data 120, unlabeled data 122, a trained classification model 124, and other computer-executable instructions by which the system 102 is configured to implement one or more aspects of the disclosed embodiments when the computer-executable instructions are executed by the one or more processor(s) 114. The system 102 is also shown including input/output (I/O) device(s) 116.

As shown in FIG. 1, storage 118 is shown as a single storage unit. However, it will be appreciated that the storage 118 is, a distributed storage that is distributed to several separate and sometimes remote and/or third-party system(s) 128 by going through a network 126. The system 102 can also comprise a distributed system with one or more of the components of the system 102 being maintained/run by different discrete systems that are remote from each other and that each perform different tasks. In some instances, a plurality of distributed systems performs similar and/or shared tasks for implementing the disclosed functionality, such as in distributed cloud environment.

The disclosed embodiments are beneficially directed to a rule induction framework for automatically inducing symbolic rules from labeled data. This rule induction framework is configured to be applied to a variety of different models in order to induce the symbolic rules. For example, these rules, once generated, can be used to amplify training signal in the unlabeled data. This is an improvement over conventional systems in that the rule induction framework produces a set of rules that allow a model training process to use unlabeled data in the training dataset, instead of being restricted to only using labeled data. Furthermore, because the training signal is amplified in the unlabeled data due to the application of one or more the automatically generated rules, the model being trained is able to more effectively leverage the unlabeled data. For example, in some instances, the application of the rules acts like a pseudo-labeling of the unlabeled data. Additionally, the rules help to isolate the most salient and unique lexical information from the combination of labeled and unlabeled data.

In some embodiments, the system is configured for a target classification task. In such embodiments, the system obtains labeled data and unlabeled data comprising text strings. The labeled data is used to generate a set of symbolic prediction functions (i.e., rules) that are configured to be applied to the text strings and output a set of labels for the text strings. Alternatively, if the symbolic prediction function (i.e., rule) is not applicable, the system refrains from outputting a label (e.g., abstaining). A machine learning model is trained on the set of symbolic prediction functions, wherein the now trained machine learning model is configured to make new classifications and predictions for new input datasets.

By way of example, assume a target classification task is given consisting of labeled classification data (e.g., L={(xᵢ,yᵢ}ᵢ₌₁^{M}) and unlabeled data (e.g., U={(x_{i+M}}ᵢ₌₁^{N}), where each xᵢ is a text string and y₁∈{1, . . . K}). In such embodiments, labeled data (e.g., labeled data L) can be used to generate a set of symbolic prediction functions (i.e., a set of rules) that take the text and output a label or abstain (e.g., rⱼ(x)∈{−1}∪{1, . . . K}). Then, the models, modified with the rules, can be used to make new classifications and predictions (e.g., as represented by P(y|x; L, U, R)).

As described previously, one key aspect for generating the rules includes the featurization of labeled and unlabeled data. To perform this functionality, the system includes a text featurization model 106 that is specifically configured to perform a featurization process on the labeled data 120 and/or unlabeled data 122. In the first step in the featurization process, the input dataset (e.g., input text, such as input text xⱼ) is converted into a binary or continuous feature space (e.g., feature space ϕ(xⱼ)∈ [symbol] ^{d} , or another feature space) that is more amenable to symbolic reasoning than the raw text. By way of further example, in some embodiments, an n-gram feature space (e.g., feature space (ϕ^{N})) and a bag-of-words model is utilized to convert the text of the text into a binary vector which reflects the presence or absence of words contained in a predefined vocabulary set.

In other embodiments, a principal component analysis (PCA) feature space (e.g., feature space (ϕ^{P}) is utilized, in particular in cases where only a small or sparse amount of labeled data is available. A data value transformation process is applied to the feature vector values by using the data value transformer 108. To perform the data value transformation process, a vector in the feature vector values is removed based on shared information from each feature vector value matrix. In more detail, the first principal component (e.g., component v) is computed of a n-gram feature matrix (e.g., matrix P∈ [symbol] ^{(M+N)×d}) constructed from both labeled and unlabeled texts in a dataset (e.g., the jth row P_{j,:}=ϕ^{N}(xⱼ):j∈[1, M+N]). The data value transformer 108 may then perform a singular value decomposition (SVD) of the n-gram feature matrix (e.g., P=UΣV^{T}).

The most common words found in the feature vector values are contained in the first principal component (e.g., component v) and can further be defined as the first column of the matrix (e.g., V∈ [symbol] ^{d×d}). The projections of all feature vectors onto the first principal component are subsequently removed. This removal process removes common information that is shared across the labeled and unlabeled data. This beneficially isolates the most unique and salient lexical phenomena in the labeled and unlabeled. In some instances, feature vectors can be symbolically represented by {ϕ^{N}(x)} onto v:

$${ϕ}^{P} ( x ) : = {ϕ}^{N} ( x ) - v \frac{{v}^{T} {ϕ}^{N} ( x )}{‖ {ϕ}^{N} ( x ) ‖ 2} .$$

The rule generator 110 is configured to automatically generate rules. After the labeled data has undergone the featurization and/or data value transform process(es) described above, symbolic rules are generated from the feature and/or transformed vector values. These rules are capable of predicting corresponding labels for new input data (e.g., unlabeled data to which the model has not been previously applied) with high precision.

In some embodiments, the rule generator utilizes a linear model which may be applied to a n-gram-based (binary) vector value feature spaces. The linear model comprises a plurality of parameters that facilitate a determination of labels based on at least analyzing the input feature vector values.

In one example embodiment, the rule generator 110 utilizes a linear model (e.g., a model represented by m(xⱼ)=σ(Wϕ(xⱼ))) containing one matrix of parameters (e.g., parameter matrix: W∈ [symbol] ^{K×V}) that determines labels from the input feature vector values. In some instances, the example linear model described above use a cross-entropy loss function, l2 regularization term, and an element-wise sigmoid function.

After labels have been determined from the input feature vector values, the system identifies a weight for each parameter included in the linear model. The system then analyzes the set of weights corresponding to the plurality of parameters and determines which sub-set of parameters have the greatest weights to select a sub-set of weights. In some embodiments, each parameter corresponds to a different input feature vector. Based on this reduced/filtered set of parameters, the system is configured to generate a rule from each weight included the sub-set of weights.

In some examples where different components of the rule generation process are represented symbolically, the rule generation process continues by selecting the [symbol] largest weights in W and subsequently creating one rule from each weight. For example, if a selected weight w_{i,k} corresponds to feature fᵢ and label k, then a rule r that predicts label k is created if the i^{th} dimension of ϕ(xⱼ) is 1. Using similar logic, if the i^{th} dimension of ϕ(xⱼ) is not equal to 1, the rule will abstain (e.g.,

$$r ( {x}_{j} ) = f ( x ) = \{ \begin{matrix}k & if ϕ ( {x}_{j} ) = 1 \\ - 1 & otherwise\end{matrix} ) .$$

In other embodiments, the rule generator 110 uses decision trees or a random forest methodology which may be applied to ngram- or PCA-based (binary or continuous) feature vector value spaces. In such embodiments, the random forest classifier comprising a plurality of decision trees. These decisions trees are configured at various depth levels within the random forest classifier. By way of example, in such instances, a random forest classifier containing [symbol] decision trees can be used at a depth of D, where the depth may be 1, 2, 3, 4, or other appropriate depth levels for a random forest classifier.

To create a rule from each decision tree, a confidence threshold (e.g., confidence threshold τ) is applied to the predicted label distribution in order to control the boundary between prediction and abstainment. For example, if a decision tree (e.g., decision tree tᵢ) outputs a probability distribution (e.g., probability distribution \hat{p}) over the labels (e.g., labels: (tᵢ(ϕ(xⱼ))=\hat{p}_{i,j}) then a rule (e.g., rule rᵢ) is created, (e.g., where

$${r}_{i} ( {x}_{j} ) = f ( x ) = \{ \begin{matrix}arg max ( {\hat{p}}_{i , j} ) & if max ( {\hat{p}}_{i , j} ) > τ \\ - 1 & otherwise\end{matrix} ) .$$

Since rules are allowed to abstain from making predictions (i.e., the system refrains from a applying a rule to a set or sub-set of data), the rule generation process may further include dynamic filtering mechanisms in some embodiments. The dynamic filter methods block rules from being applied to specific examples where the rule is likely to make errors. By implementing these dynamic filtering mechanisms, the disclosed embodiments achieve improved technical benefits, including increasing the precision of the set of rules and increasing the fidelity of downstream rule integration activities. Additionally, by preventing misapplication of rules, this also prevents the propagation of such errors down through to subsequent applications and tasks.

In some embodiments, a training accuracy method is utilized to refine rules. To improve training accuracy, a proportion of errors are randomly sampled and the incorrectly predicted value is replaced with abstainment (−1), or another label that discounts or causes a predicted value to be disregarded. The proportion of these errors may be 10%, or 20%, or 30%, or 40%, or 50%, or 60%, or 70%, or 80%, or 90%, or any value between any two of the previously mentioned values. For example, the data value transformer reduces the plurality of feature vectors to the plurality of transformed feature vector values by 10 to 90 percent, or 20 to 70 percent, or 25 to 50 percent.

In other embodiments, a semantic coverage method is used to refine rules. A filter is designed to ensure that in cases where at least one rule is applied, that the sampled data resembles the training set. In one embodiment, after a rule (e.g., rule rᵢ) is applied to input text (e.g., input text xⱼ), a predicting label rᵢ(xⱼ)=1, the Sentence BERT framework and a pretrained mpnet model are used to obtain embeddings for the input sentence xⱼ as well as for all training samples that have the same label as the rule's prediction: {xᵢ∈L: yᵢ=l}.

The rule filtering process determines the cosine similarity between the input's embedding and the training set embedding and if the maximum of these similarities is below a predetermined threshold then the rule rᵢ is blocked from being applied and the label is then replaced with abstainment (−1). In this manner, the rule filtering process can be utilized to prevent the system from misapplying a rule and generating a faulty label for the input data. For instance, if the predicted label is associated with a low confidence rating (e.g., likely to have been wrongly predicted by a rule), the input data is marked with the abstainment label which is indicative of this rule filtering/evaluation process to keep it from being applied. The predetermined threshold may set to different levels to accommodate different needs and preferences (e.g., a threshold value of 0.2, or 0.3, or 0.4, or 0.5, or 0.6, or 0.7, or 0.8, or 0.9, or some value between any two of the previously listed values, or less than 0.2 or greater than 0.9.

The next system model/component in FIG. 1 to be described is the model tuning module 112 which is configured to tune and optimize the trained classification model 124 using the rules generated from the rule generator 110 and the labeled and/or unlabeled data which has further been labeled using the rules and is referred to as weak labeled data. As described throughout, the rules generated by the rule generator 110 and the unlabeled data 122 are leveraged by the model tuning module 112 to be used as extra training signal(s).

In some embodiments, the model tuning module 112 tunes the trained classification model 124, which is the original trained classification model, by use of a backbone classification model (e.g., BERT) and a rule aggregation layer. In particular, in some embodiments, the aggregation layer uses an attention mechanism to combine the outputs of the backbone model and generated rules. The parameters of the backbone and aggregator are jointly trained via a self-training procedure over the labeled and unlabeled data. For example, the backbone model may be a standard BERT-based classifier with a prediction head attached to the [CLS] embedding which outputs a probability distribution over the possible labels.

Furthermore, the aggregation layer may be trained to optimally combine the predictions of the backbone model and rules by use of an attention model. For example, the aggregation layer initializes trainable embeddings for each rule, and embedding for the backbone. Subsequently, the aggregation layer computes dot-product attention scores between the previously defined embeddings and an embedded version of the text data. The final model prediction is a weighted sum of the backbone and rule predictions, where the weights are determined by the attention scores.

More specifically, in some embodiments, the system applies the set of rules on input data, wherein the function returns an encoded output of the input data. The system is then configured to apply the aggregation layer which computes a probability distribution over the labels. For example, if the set of rules activated on input xᵢ is Rᵢ={rⱼ∈ [symbol] : rⱼ(xᵢ)≠1}, and the function g(⋅)∈ [symbol] ^{K} (returns a one-hot encoding of its input, then the aggregation layer computes a probability distribution over the labels:

$$a ( {x}_{i} ) = \frac{1}{Q} ( {Σ}_{j : {r}_{{j}^{∈ R} t}} {s}_{i}^{j} g ( {r}_{i} ( {x}_{i} ) ) + {s}_{i}^{s} b ( {x}_{i} ) + u$$

where the attention scores are calculated as, sᵢ^{j}=σ(p(hᵢ)·eⱼ) , p is a multi-layer perceptron that projects the input representation hᵢ into a shared embedding space, Q is a normalizing factor to ensure a(xᵢ) is a probability distribution, σ(⋅) is a sigmoid function, and u is a uniform smoothing term.

The model tuning module 112 may continue to train the overall system, in some embodiments, by pretraining the backbone on the labeled data 120. The backbone and aggregation layer are further trained through an iteratively co-train process by freezing the backbone parameters and training the aggregator and then freezing the aggregator and training the backbone layer. When a layer is frozen during training, that layer is not modified when the model is applied to the training data during the training process. For example, when freezing the backbone parameters, only the aggregator is modified during the iterative co-train process. Then, when the aggregator is frozen, only the backbone layer is modified during the iterative co-train process.

The process may further be broken down as follows. The backbone s is trained using the labeled data and a cross-entropy loss function, (e.g., where b(xᵢ)_{y}_{ᵢ} denotes the logit for the ground truth class yᵢ: [symbol] ₛₜᵤ^{sup}=−Σ₍ₓ_{ᵢ}_{, y}_{ᵢ}_{)∈L} log b(xᵢ)_{y}_{ᵢ}). This step in the process is followed by training the aggregator (e.g., aggregator t) on labeled data using a cross-entropy loss function (e.g., cross-entropy loss function [symbol] ₜₑₐ^{sup}=−Σ₍ₓ_{ᵢ}_{y}_{ᵢ}_{)∈L} log a(xᵢ)_{y}_{ᵢ}) and subsequently training the aggregator on unlabeled data with a minimum entropy objective. The process of training the aggregator on labeled and unlabeled data may be repeated until convergence is reached, wherein the convergence is determined by a predetermined threshold.

The process described above results in the aggregator learning attention scores that favor rule agreement. Less importance is given to spurious rules that disagree. In some instances, this is described by: [symbol] ₜₑₐ^{unsup}=−Σₓ_{ᵢ}_{∈U}a(xᵢ)^{T} log a(xᵢ) where log a(xᵢ)∈ [symbol] ^{k} denotes the element-wise logarithm of the probability distribution a(xᵢ). Lastly, the backbone is trained on labeled data (e.g., by using: [symbol] ₛₜᵤ^{sup}=−Σ₍ₓ_{ᵢ}_{,y}_{ᵢ}_{)∈L} log b(xᵢ)_{y}_{ᵢ}), and then the backbone is further trained the backbone on unlabeled data by distilling from the aggregator.

For example, the backbone may be trained to mimic the aggregator's output (e.g., output: [symbol] ₛₜᵤ^{unsup}=−Σₓ_{ᵢ}_{∈U}a(xᵢ)^{T} log b(xᵢ)). Once this process is completed, the outputs of either the backbone or aggregator may be used for inference. For example, if the aggregator is used, the attention scores (e.g., attention scores sᵢ^{j}) may be interpreted to understand what proportion of the system's decision was due to each rule.

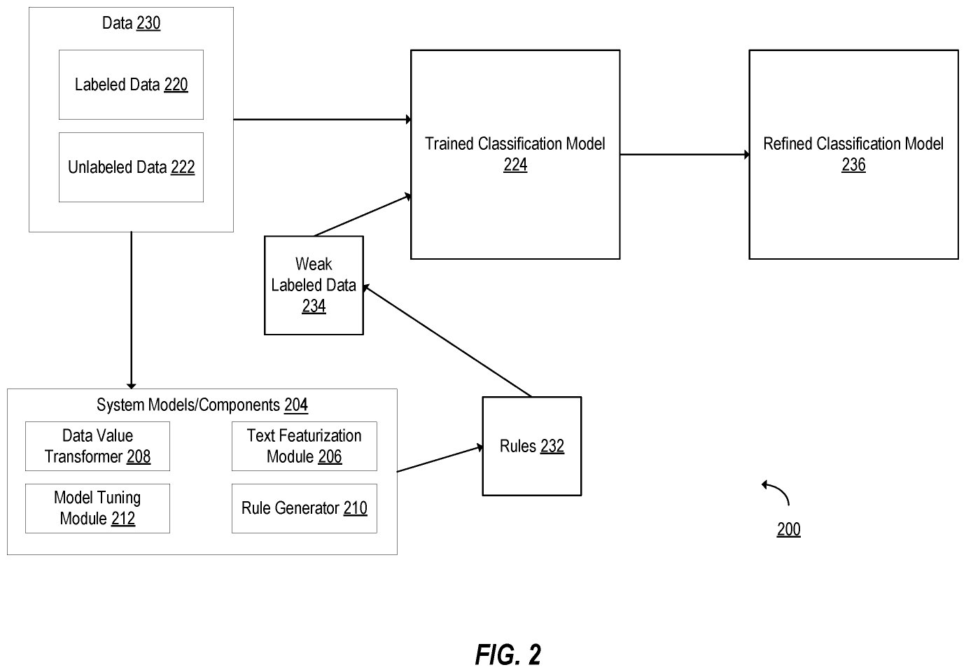

Attention will now be directed to FIG. 2 illustrates an example embodiment of flow diagram 200 that visually represents the refining/training of a pretrained text classification model with data 230 including labeled data 220 and unlabeled data 222. As shown, the labeled data 220 and/or the unlabeled data 222 are provided as inputs to the various system models/components 204 during the training process(es). It is noted that the various models/components 204 of the classification model, which includes the text featurization model 206, the data value transformer 208, the rule generator 210, and the model tuning module 212, have all been described in more detail (above) in the descriptions of FIG. 1. For example, various models/components 204 is representative of system models/components 104, including text featurization module 206 which is representative of text featurization module 106, data value transformer 208 which is representative of data value transformer 108, rule generator 210 which is representative of rule generator 110, and model tuning module 212 which is representative of model tuning module 112.

More particularly, the text featurization module 206 is configured to perform a featurization and/or vectorization process on input data comprising raw text in order to convert the raw text into feature vector values. The data value transformer 208 is configured to transform the feature vector values into transformed feature vector values. The rule generator 210 is configured to generate a set of rules from the transformed vector values.

As reflected in the flow of FIG. 2, and as previously described, the various system models/components 204 generate output rules 232 during a rule generation process, which are applied to the labeled data 220 and the unlabeled data 222 to create a new set of weak labeled data 234. Then, this weak labeled data 234, alone or in combination with any of the data 230 or other new labeled data, is applied to the trained classification model 224 to generate a refined classification model 236.

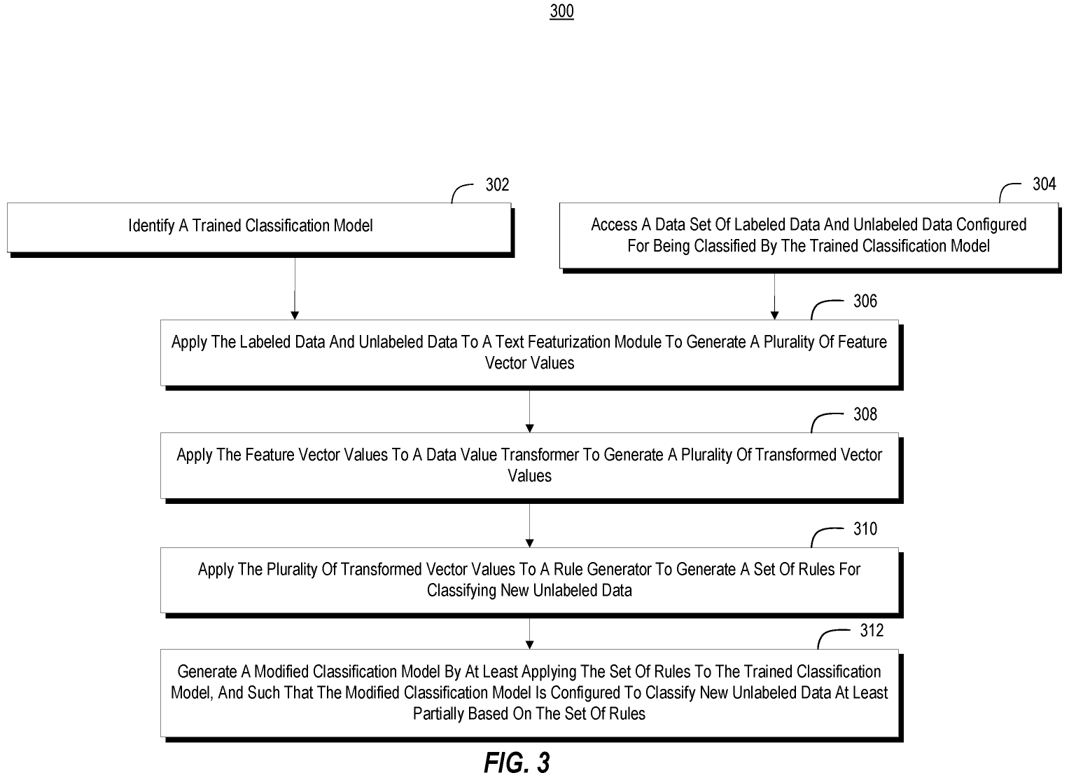

Attention will now be directed to FIG. 3 which illustrates a flow diagram 300 that includes various acts (act 302, act 304, act 306, act 308, act 310, and act 312) associated with exemplary methods that can be implemented by the system 102 for generating rules and tuning a classification model.

The first illustrated act includes a system, such as system 100 of FIG. 1, identifying a trained classification model (act 302). In some instances, the trained classification model is a model trained (or pretrained) on a first dataset and which has not been previously trained for a new/subsequent dataset that includes at least some data objects that comprise unlabeled training data. In some instances, the trained classification model is a language model.

The next illustrated act includes the system accessing a data set of labeled data and unlabeled data configured for being classified by the trained classification model (act 304). The system beneficially accesses a combination of labeled and unlabeled data in order to employ a semi-supervised training of the trained classification model which takes advantage of available labeled data while being able to increase the amount of training data by supplementing the limited available labeled data with unlabeled data. For example, when the trained classification model comprises a language model, the referenced labeled and unlabeled data will comprise native or transcribed text data that are processed and subsequently classified by the language model.

Subsequently, the system applies the labeled data and unlabeled data to a text featurization module to generate a plurality of feature vector values (act 306). For example, in some instances, the system generates a plurality of feature vector values by converting the dataset of labeled data and unlabeled data to a feature space. By converting the labeled and unlabeled data (which is raw text) to feature vector values, the raw text is transformed into data that is more amenable to symbolic reasoning than raw text. Symbolic reasoning is beneficial in generating more accurate rules that represent or symbolize the information learned through the labeled and unlabeled data. In some instances, the text featurization module applies a bag-of-words functionality when performing the text featurization. The bag-of-words functionality is beneficially configured to convert each text string into a binary vector which reflects he presence or absence of words in a vocabulary. In other or additional embodiments, the text featurization module implements a principal component analysis (PCA) technique when performing the text featurization. By implementing a PCA technique, the system achieves technical benefits such as removing common information that is shared across many texts and simultaneously isolating the most unique and salient lexical phenomena. This improves downstream analysis and use of the feature vector values by providing a targeted and refined set of lexical information extracted from the raw text. This in turn produces more refined feature vector values.

The system then applies the feature vector values to a data value transformer to generate a plurality of transformed vector values (act 308) associated with the text features. In such embodiments, the system is configured to generate a plurality of transformed vector values based on at least the plurality of feature vector values, wherein the transformed vector values comprise unique information not shared between the unlabeled and labeled data (i.e., the information shared between the unlabeled and labeled is removed by the system applying the feature vector values to the rule generator. In some embodiments, the data value transformer reduces the plurality of feature vector values to a plurality of transformed vector values by 10 to 90 percent or by any other range between 10 to 90 percent. Certain embodiments may apply the data value transformer more than once creating multiple transformed vector values. In such examples, the system applies the data value transformer to the plurality of transformed vector values in order to generate a plurality of newly transformed vector values one or more times.

The system then applies the plurality of transformed vector values to a rule generator to generate a set of rules for classifying new unlabeled data (act 310). For example, the system is configured to generate a set of rules based on the plurality of transformed vector values. The set of rules configured to classify new unlabeled data based on at least the transformed vector values.

By applying the transformed vector values to the rule generator, the system is able to generate symbolic rules from the features which are capable of predicting the labels with improved precision over conventional rule generation systems. In some embodiments, the rule generator generates rules using a linear model performed on the plurality of transformed vector values. In other embodiments, the rule generator generates rules using a random forest model performed on the plurality of transformed vector values. Some embodiments may include a rule refining method which may include either a training accuracy method or a semantic coverage method. By implementing either the training accuracy method or the semantic coverage method, the system is configured for updating the set of rules which is refined and/or optimized set of rules.

Lastly, a modified classification model is generated by at least applying the set of rules to the trained classification model, and such that the modified classification model is configured to classify new unlabeled data at least partially based on the set of rules (act 312). This may be performed by generating weak labels by applying the rules created by the rule generator to the unlabeled data.

By modifying the trained classification model with the set of rules, the modified classification model which is an improved classification model over conventional classification models. For example, this automatic rule induction framework improves over existing text classification systems which did not have a symbolic-hybrid architecture, relied on manually designed symbols, and/or relied on application-specific symbolic logic. Here, the disclosed embodiments are directed to an improved classification model which beneficially employs a symbolic-hybrid architecture, leverages automatically generated symbols (e.g., rules), and is configured to utilize general-purpose logic instead of limited application-specific logic (i.e., the classification model is able to generate generalized rules that apply in a variety of applications).

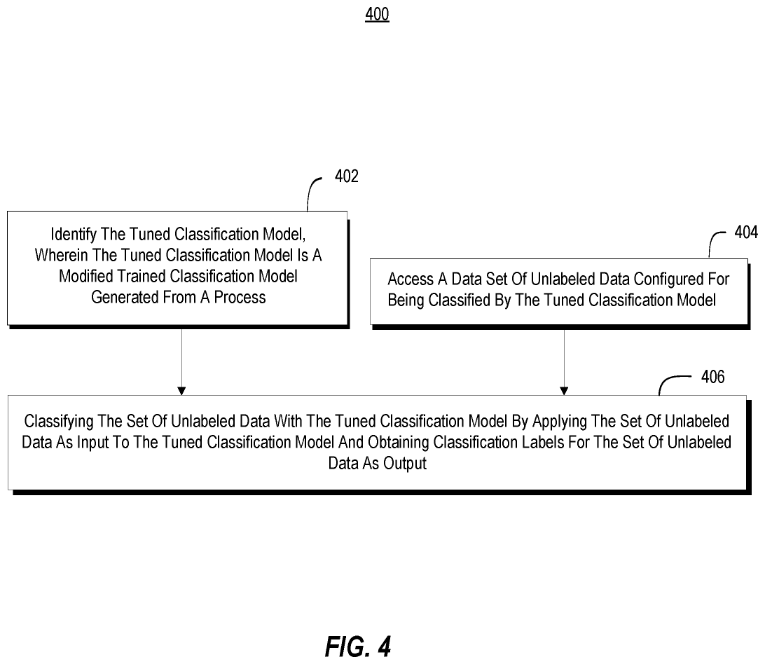

Attention will now be directed to FIG. 4 which illustrates a flow diagram 400 that includes various acts (act 402, 404, and 406) associated with exemplary methods that can be implemented by a system 102 for labeling unlabeled data with a tuned classification model.

The first illustrated act includes an act of identifying the tuned classification model, wherein the tuned classification model is a modified trained classification model generated from a process (act 402) described in detail above by FIG. 3. For example, the system is configured to identify a tuned classification model which has been generating based on modifying a trained classification model with a set of rules automatically induced from a set of labeled data and unlabeled data by the trained classification model, wherein the tuned classification model is configured to classify new unlabeled data using the set of rules.

By accessing a tuned classification model according to the embodiments described herein, the system is able to generate improved rules which are able to predict labels for unlabeled data with higher precision than conventional systems/models. The system then accesses a data set of unlabeled data configured for being classified by the tuned classification model (act 404).

Subsequently, the set of unlabeled data is classified with the tuned classification model by applying the set of unlabeled data as input to the tuned classification model and obtaining classification labels for the set of unlabeled data as output (act 406). In this manner, the tuned classification model can be utilized to generate an improved output (e.g., classified data) relative to conventional systems, by providing classification labels that are based on the newly generated, filtered and applied rules. Output from such a modified model will be of a higher quality and more accurate labels than the models prior to such modification. These modifications additionally further improve downstream applications which subsequently utilize the classified data generated from the modified model(s).

In some embodiments, the rule applied to the unlabeled data will determine whether the unlabeled data is spam where the unlabeled data may be messages, videos, attachments, or other types of data that may contain spam. Other embodiments may apply rules that determine a topic in cases where the unlabeled data is an article or other data that may relate to specific topics. Some embodiments may apply rules to unlabeled data which determine ratings for unlabeled data such as video games, movies, media, or other types of data that may be classified by ratings.

Other embodiments may include rules that determine the type of section in an article where the unlabeled data may be a scientific manuscript. Furthermore, embodiments may include rules that determine functional relationships between chemicals and proteins in applicable unlabeled data sets. Some embodiments may use rules to determine the conversational question intent (e.g., a conversational question intent for a spoken or written language utterance) in unlabeled data which contains conversational data.

After the classification model is trained/tuned to generate classified data, as just described, the classification model can then be used to generate large sets of labeled data with a high degree of accuracy. Then this new labeled data can be subsequently applied to and used to train/tune other pre-trained Al models (e.g., speech models, automatic speech recognition models, natural language processing models, etc.).

While many of the foregoing embodiments describe training/tuning of a pre-trained model, it will also be appreciated that the processes and techniques described can be applied to models that are already trained or tuned for a particular end-use scenario to fine-tune the model to perform even more accurately. For instance, a model that is already trained and configured to classify data in a primary dataset that is applicable to a plurality of customers can be further fine-tuned for a particular customer by applying a new customer specific dataset to the model. The new customer specific dataset may include some unlabeled data that is specific to the new customer and that is not part of the primary dataset. By using the processes described above, in reference to FIGS. 3 and 4, it is possible to generate and apply new training data for fine-tuning the model for the new customer based on the new customer specific dataset.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some embodiments, the functionality described in reference to FIGS. 1-4 is implemented by systems or incorporated within systems that are configured to perform the referenced functionality in response to one or more hardware processors executing stored computer-executable instructions.

Such computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code.

The computer-executable instructions, which may be configured as data structures, may be received over a network or data link can be buffered in RAM within a network interface module (e.g., a “NIC”), and then eventually transferred to computer system RAM and/or to less volatile computer-readable physical storage media at a computer system where they are executed/executable by one or more processors of the computer system.

The referenced computer-readable physical storage media can include one or more hardware storage devices including, but not limited to, system memory, RAM, ROM, and other hardware storage. In some embodiments, the computer-executable instructions can also be transmitted over transmission media. Some configurations of storage media include combinations of physical storage media and transmission media.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for modifying a trained classification model, comprising:
identifying a trained classification model;
accessing a dataset of labeled data and unlabeled data configured for being classified by the trained classification model;
generating a plurality of feature vector values by converting the dataset of labeled data and unlabeled data to a feature space;
generating a plurality of transformed vector values based on at least the plurality of feature vector values;
generating a set of rules based on the plurality of transformed vector values, the set of rules configured to classify new unlabeled data based on at least the transformed vector values;
generating a modified classification model by at least applying the set of rules to the trained classification model, and such that the modified classification model is configured to classify a dataset of new unlabeled data at least partially based on the set of rules.

2. The computer-implemented method of claim 1, wherein the trained classification model is a language model.

3. The computer-implemented method of claim 1, wherein the dataset of labeled and unlabeled data are text data.

4. The computer-implemented method of claim 1, wherein the text featurization module implements a bag of word model.

5. The computer-implemented method of claim 1, wherein the text featurization module implements a principal component analysis (PCA) method.

6. The computer-implemented method of claim 1, wherein the data value transformer reduces the plurality of feature vector values to the plurality of transformed vector values by 10 to 90 percent, or 20 to 70 percent, or 25 to 50 percent.

7. The computer-implemented method of claim 1, wherein the rule generator generates rules using a linear model performed on the plurality of transformed vector values.

8. The computer-implemented method of claim 1, wherein the rule generator generates rules using a random forest model performed on the plurality of transformed vector values.

9. The computer-implemented method of claim 1, further comprising:
applying the plurality of transformed vector values to the data value transformer to generate a plurality of newly transformed vector values one or more times.

10. The computer-implemented method of claim 1, further comprising:
generating one or more weak labels by applying the set of rules created by the rule generator to unlabeled data.

11. The computer-implemented method of claim 1, further comprising:
updating the set of rules using a training accuracy method.

12. The computer-implemented method of claim 1, further comprising:
updating the set of rules using a semantic coverage method.

13. A system for modifying a trained classification model, comprising:
one or more processors; and
one or more storage device having stored computer-executable instructions which are executable by the one or more processors to configure the system to implement a method for modifying the trained classification model by at least configuring the system to perform a following:
identify a trained model;
access a dataset of labeled data and unlabeled data configured for being classified by the trained model;
apply the dataset of labeled data and unlabeled data to a text featurization module to generate a plurality of feature vector values;
apply the plurality of feature vector values to a data value transformer to generate a plurality of transformed vector values;
apply the plurality of transformed vector values to a rule generator to generate a set of rules for classifying new unlabeled data; and
generate a modified classification model by at least applying the set of rules to the trained classification model, and such that the modified classification model is configured to classify a dataset of new unlabeled data at least partially based on the set of rules.

14. A computer-implemented method for applying unlabeled data to a tuned classification model to classify the unlabeled data, comprising:
identifying a tuned classification model which has been generating based on modifying a trained classification model with a set of rules automatically induced from a set of labeled data and unlabeled data by the trained classification model, wherein the tuned classification model is configured to classify new unlabeled data using the set of rules;
accessing a dataset of unlabeled data configured for being classified by the tuned classification model; and
classifying the dataset of unlabeled data with the tuned classification model by applying the dataset of unlabeled data as input to the tuned classification model and obtaining classification labels for the dataset of unlabeled data as output from the tuned classification model.

15. The computer-implemented method of claim 14, further comprising:
applying a rule from the set of rules to the dataset of unlabeled data that determines whether a message, video, or attachment included in the dataset of unlabeled data is spam.

16. The computer-implemented method of claim 14, further comprising:
applying a rule from the set of rules to the dataset of unlabeled data that determines a topic of an article included in the dataset of unlabeled data.

17. The computer-implemented method of claim 14, further comprising:
applying a rule from the set of rules to the dataset of unlabeled data that determines a rating of a game, movie or other media included in the dataset of unlabeled data.

18. The computer-implemented method of claim 14, further comprising:
applying a rule from the set of rules to the dataset of unlabeled data that determines sections of a scientific manuscript included in the dataset of unlabeled data.

19. The computer-implemented method of claim 14, further comprising:
applying a rule from the set of rules to the dataset of unlabeled data that determines a functional relationship between chemicals and proteins referenced in the dataset of unlabeled data.

20. The computer-implemented method of claim 14, further comprising:
applying a rule from the set of rules to the dataset of unlabeled data that determines a conversational question intent for a language utterance included in the dataset of unlabeled data.

21. A system for applying unlabeled data to a tuned classification model to classify the unlabeled data, comprising:
one or more processors; and
one or more storage device having stored computer-executable instructions which are executable by the one or more processors to configure the system to implement a method for modifying a trained classification model by at least configuring the system to perform a following:
identify the tuned classification model, wherein the tuned classification model is a modified trained classification model generated from a process that includes:
identify a trained classification model,
access a dataset of labeled data and unlabeled data configured for being classified by the trained classification model,
apply the dataset of labeled data and unlabeled data to a text featurization module to generate a plurality of feature vector values,
apply the plurality of feature vector values to a data value transformer to generate a plurality of transformed vector values,
apply the plurality of transformed vector values to a rule generator to generate a set of rules for classifying new unlabeled data, and
generate a modified classification model by at least applying the set of rules to the trained classification model, and such that the modified classification model is configured to classify new unlabeled data at least partially based on the set of rules;
access a dataset of unlabeled data configured for being classified by the tuned classification model; and
classify the dataset of unlabeled data with the tuned classification model by (i) applying the dataset of unlabeled data as input to the tuned classification model and (ii) obtaining classification labels for the dataset of unlabeled data as output from the tuned classification model.
